(19) United States
(12) Patent Application Publication
(10) Pub. No.: US 2005/0074120 A1
(43) Pub. Date: Apr. 7, 2005

(54) Cryptography systems and methods

(76) Inventor: Brani Vidakovic, Marietta, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/953,659

(22) Filed: Sep. 29, 2004

Related U.S. Application Data
(60) Provisional application No. 60/508,140, filed on Oct. 2, 2003.

(51) Int. Cl. H04N 7/167; H04K 1/00

(52) U.S. Cl. 380/255

(57) ABSTRACT

Embodiments of a cryptography system and method are disclosed. One embodiment includes a processor configured with logic to transform data into a wavelet domain, encode the transformed data, and effect transmission of the encoded data.

### CROSS-REFERENCE TO RELATED APPLICATION

This application claims the benefit of U.S. provisional application No. 60/508,140, filed Oct. 2, 2003, which is entirely incorporated herein by reference.

### TECHNICAL FIELD

The present invention is generally related to data security, and, more particularly, is related to cryptography systems and methods.

### BACKGROUND

Data and information security is critical nowadays with a vast quantity of data exchanged daily over national and international information highways. Areas as diverse as cable and satellite communication, telephony, among other fields of communication, are effected by data security. When securely coding data, two seemingly opposed goals may be of interest. One goal is to provide maximum protection against unauthorized decoding. Another goal is to provide robustness in handling the coded object, such that data integrity is preserved in the midst of channel and/or communication imperfections that cause transmission errors, noisy corruption of the code, etc. Current communication systems can benefit from data security systems that can achieve these goals.

### SUMMARY OF THE INVENTION

Preferred embodiments of a cryptography system and method are disclosed. One embodiment of a method, among other embodiments, includes transforming data into a wavelet domain, encoding the transformed data, and transmitting the encoded data.

Another embodiment of a cryptography method includes receiving an encoded key and encoded data, decoding the encoded key, and inverse wavelet transforming the encoded data using the decoded key.

An embodiment of a cryptography system, among other embodiments, includes a first processor configured with first logic to transform data to a wavelet domain, encode the transformed data, and effect transmission of the encoded data.

Another embodiment of a cryptography system includes a first processor configured with logic to receive an encoded key and encoded data, decode the encoded key, and inverse wavelet transform the encoded data using the decoded key.

Other systems, methods, features, and advantages will be or become apparent to one with skill in the art upon examination of the following drawings and detailed description. It is intended that all such additional systems, methods, features, and advantages be included within this description and be within the scope of the disclosure.

### BRIEF DESCRIPTION OF THE DRAWINGS

Many aspects of embodiments of a cryptography system and method can be better understood with reference to the following drawings. The components in the drawings are not necessarily to scale, emphasis instead being placed upon clearly illustrating the principles of cryptography systems and methods. Moreover, in the drawings, like reference numerals designate corresponding parts throughout the several views.

FIG. 1 is a block diagram depicting an example network infrastructure for implementing an embodiment of a cryptography system.

FIG. 2A is a block diagram of a computer embodiment that can implement an encoding-side portion of the cryptography system shown in FIG. 1.

FIG. 2B is a block diagram of a computer embodiment that can implement a decoding-side portion of the cryptography system shown in FIG. 1.

FIG. 3 is a flow diagram that illustrates an embodiment of a method employed by the cryptography system shown in FIG. 1.

FIGS. 4A-4B are simulated plots that depict wavelet and scaling functions implemented by the cryptography system shown in FIG. 1.

FIGS. 5A-5B are simulated plots that depict m-function, low pass wavelet filter functions from a two-parameter Pollen family as implemented by the cryptography system shown in FIG. 1.

FIGS. 6A and 6B are simulated plots that show the difference between an original and recovered numerical sequences based on minute key differences as implemented by the cryptography system shown in FIG. 1.

### DETAILED DESCRIPTION OF THE PREFERRED EMBODIMENTS

Preferred embodiments of a cryptography system and method (herein referred to as a cryptography system) are disclosed. A cryptography system includes a coding/decoding paradigm that is based on lossless orthogonal wavelet transformations and their corresponding inverses. Wavelets are local functions that form an orthogonal basis capable of representing other functions, signals, and data sets. Wavelet representations are parsimonious and local in the sense that non-stationary phenomena is coded in an optimally spacious and economic way. Non-stationary phenomena include phenomena that produce intermittent measurements of trends and variances. The output is characterized by local behavior (e.g., bursts, smoothness, etc.) that may not or cannot be described globally. Wavelet transformations are representations of functions, signals, or data in terms of wavelet coefficients. Such transforms are fast (e.g., faster than fast Fourier transforms), versatile, and convenient for further data processing functions, such as smoothing, coding, self-similarity assessing, state-of-art statistical inference, etc.

A cryptography system includes a key that is used for coding and decoding numerical data that represents a given object, such as text, sound, or video. A cryptography system is sensitive to changes in the coding/decoding key, while allowing for moderate corruption of the coded object in the channel of communication without substantially impairing the reproduction of the decoded object. Thus, a cryptography system provides simultaneous, robust handling of coded data, insensitivity to transmission errors, sensitivity with respect to accuracy of decoding keys, and a low calculational complexity (i.e., O(n)). Whitening and disbalancing properties, common to wavelet transformations (see Vidakovic, B., statistical Modeling by Wavelets, 1999, pp. 94-95, herein incorporated by reference), enable errors to be distributed to coded areas having no information value, thus protecting highly localized areas where most of the information resides. Wavelet transforms compress the relevant information contained in the energy of a signal in only a few wavelet coefficients. One benefit of this feature is that, if a transmission channel is noisy, it does not significantly affect the information, compared to the same corruption of the data in the non-transformed domain. Further, a wavelet transformation is a linear process and thus can be implemented more efficiently and with greater ease than polynomial or exponential transformations (e.g., fast Fourier transforms, or FFTs).

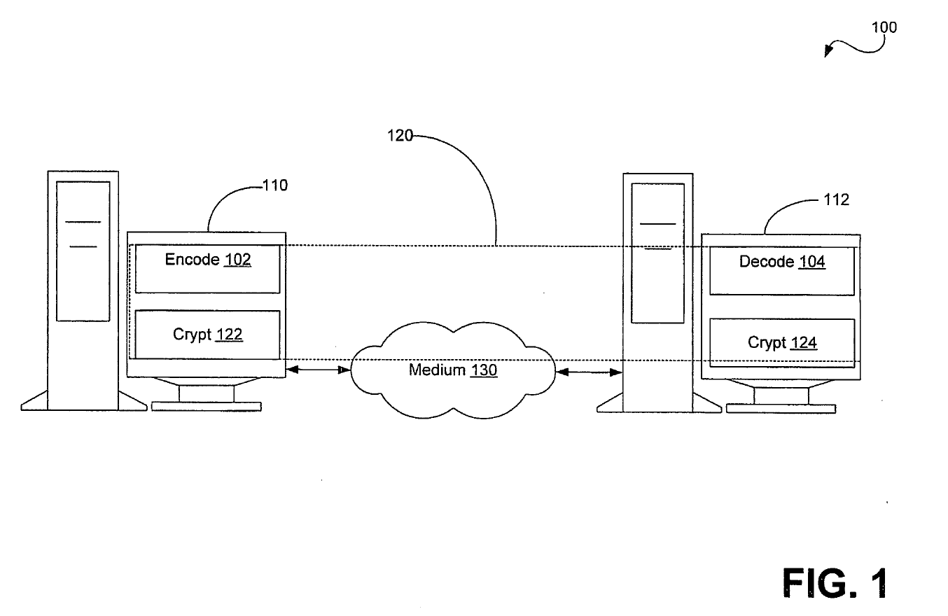

FIG. 1 is a block diagram depicting an example network infrastructure 100 for implementing an embodiment of a cryptography system 120. The network infrastructure 100 can be implemented as a cable or satellite communication system, a fiber optic link, a cellular phone system, a local area network (LAN), wide area network (WAN), the Internet, among other systems and networks. The network infrastructure 100 includes a first computer 110 that is in communication with a second computer 112 via a medium 130. The first computer 110 includes an encode module 102 and a cryptography module 122. The second computer 112 includes a decode module 104 and a cryptography module 124. In one embodiment, the cryptography system 120 includes the encode module 102, the cryptography module 122, the decode module 104, and the cryptography module 124. Additional components, such as memory, other processing devices, and/or the computers 110 and 112, may be included in the cryptography system 120. In some embodiments, the cryptography system 120 can be implemented internally to a single device, such as a consumer electronics device like a digital video disk (DVD) player, a compact disk (CD) player, or a memory array structure, among other systems and devices where the communication can occur over the medium 130 in the form of an internal bus or wiring between components that implement encoding, decoding, and/or cryptography functionality.

The encode module 102 includes functionality for encoding data for transmittal over the medium 130. The cryptography module 122 cooperates with the encode module 102 to provide secure data encoding. For example, the encode module 102 and the cryptography module 122 may cooperate to transform information into numerical data, select one or more wavelet transforms, perform one or more wavelet transformations, and generate and send one or more keys (which will be used at the second computer 112 to perform inverse transformation of the coded data to reproduce the original information) that corresponds to the selected wavelet transform. The keys can be transmitted with or separate from the coded data over the medium 130. The key can be changed periodically, such as every day, week, month, year, etc., to provide further protection against unauthorized access to or use of the secured information. Additional operations are also possible, such as compression of the coded data according to the syntax and semantics of a variety of coding methods (e.g., MPEG, etc.). Although the encode module 102 is shown as a module separate from the cryptography module 122, functionality of each may be merged in a single module or device. Additionally, the encode module 102 and the cryptography module 122 may be included in other components, such as a transmitter in a telephone system or in a fiber optic link.

The medium 130 includes media for providing a conduit for transferring information, including free space, fiber optic, hybrid fiber/coax (HFC), cable, Ethernet, T1, internal bus wiring, etc. Data can be transferred over the medium 130 according to a number of protocols, including HTTP and/or FTP, among others.

The decode module 104 includes functionality for decoding data transmitted over the communications medium 130. The cryptography module 124 cooperates with the decode module 104 to reproduce the secured data to its original format. Although the decode module 104 is shown as a module separate from the cryptography module 124, functionality of each may be merged in a single module or device. Additionally, although the decode module 104 and cryptography module 124 are shown in the computer 112, functionality of the same can be included in such devices as a receiver, set-top box, among other systems or devices that include decoding functionality and which can provide a direct output to a user and/or transfer information to another component or device.

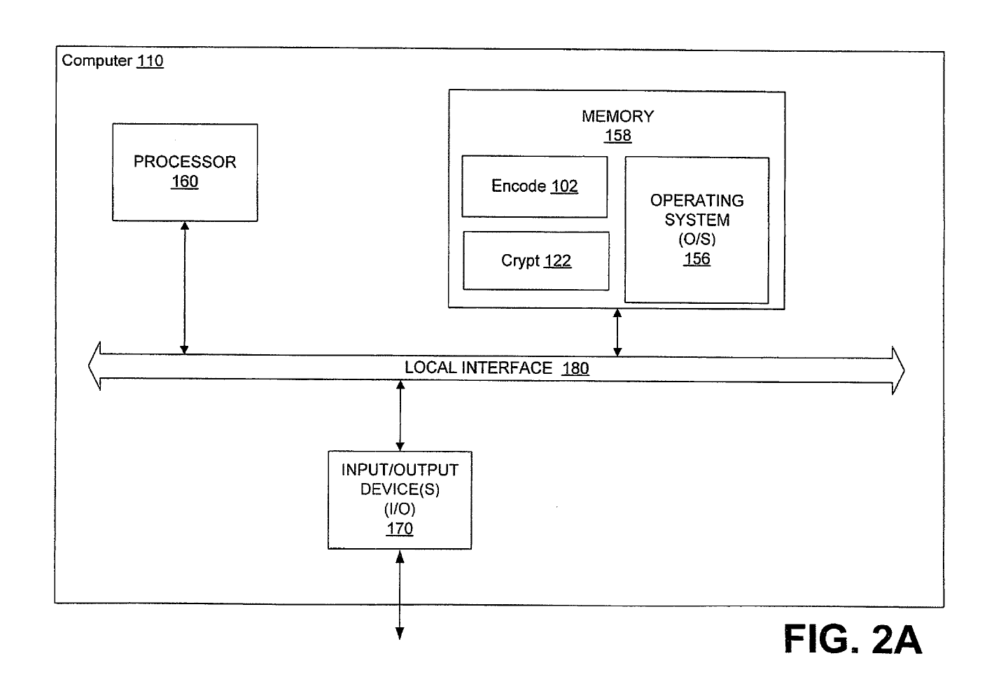

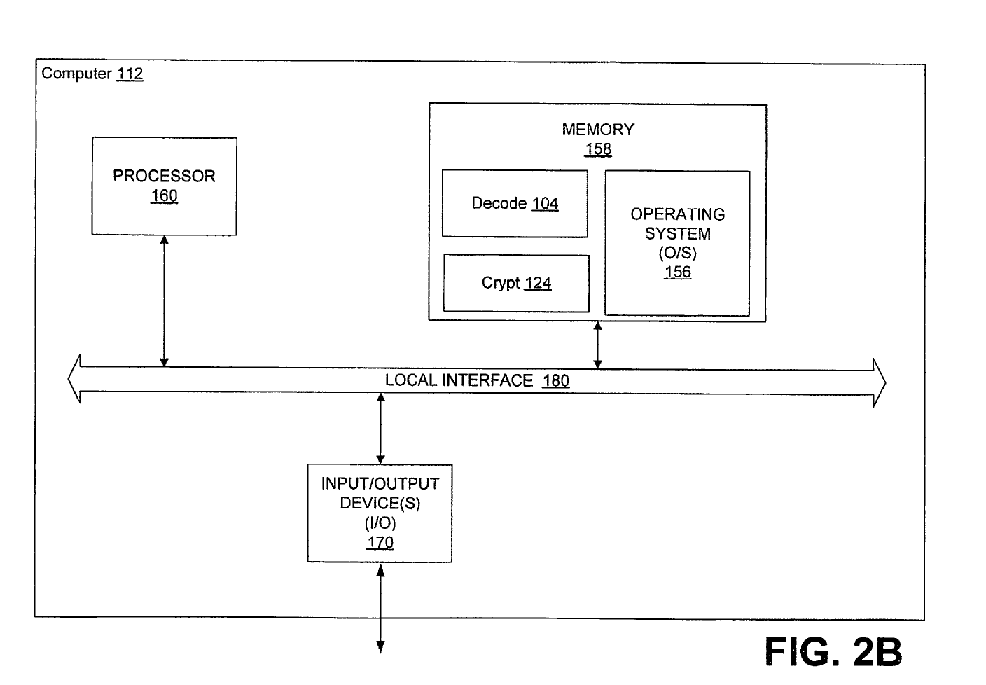

FIG. 2A is a block diagram of the example first computer 110 that, in one embodiment, can implement the encode module 102 and the cryptography module 122 of the cryptography system 120 (FIG. 1). One skilled in the art will understand that additional components or different components with similar functionality can be included in the first computer 110, and/or some components can be omitted, in some embodiments. In one embodiment, the encode module 102 and the cryptography module 122 can be implemented in software, as an executable program, and can be executed by a special or general purpose digital computer, such as a personal computer (PC; IBM-compatible, Apple-compatible, or otherwise), workstation, minicomputer, or mainframe computer.

Generally, in terms of hardware architecture, as shown in FIG. 2A, the first computer 110 includes a processor 160, memory 158, and one or more input and/or output (I/O) devices 170 (or peripherals) that are communicatively coupled via a local interface 180. The local interface 180 can be, for example, one or more buses or other wired or wireless connections. The local interface 180 may have additional elements (not shown) to enable communications, such as controllers, buffers (caches), drivers, repeaters, and receivers. Further, the local interface 180 may include address, control, and/or data connections to enable appropriate communications among the aforementioned components.

The processor 160 is a hardware device capable of executing software, particularly that stored in memory 158. The processor 160 can be any custom made or commercially available processor, a central processing unit (CPU), an auxiliary processor among several processors associated with the first computer 110, a semiconductor based microprocessor (in the form of a microchip or chip set), a macroprocessor, or generally any device for executing software instructions.

Memory 158 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 158 may incorporate electronic, magnetic, optical, and/or other types of storage media. Note that memory 158 can have a distributed architecture, where various components are situated remotely from one another, but can be accessed by the processor 160.

The I/O devices 170 may include input devices, such as a keyboard, mouse, scanner, microphone, etc. Furthermore, the I/O devices 170 may also include output devices, such as a printer, display, etc. The I/O devices 170 may further include devices that communicate both inputs and outputs, for instance a modulator/demodulator (modem; for accessing another device, system, or network), a radio frequency (RF) or other transceiver, a telephonic interface, a bridge, a router, etc.

When the first computer 110 is in operation, the processor 160 is configured to execute software stored within memory 158, to communicate data to and from memory 158, and to generally control operations of the first computer 110 pursuant to the software. The encode module 102, cryptography module 122, and the operating system 156, in whole or in part, but typically the latter, are read by the processor 160, perhaps buffered and then executed.

FIG. 2B is a block diagram of the second computer 112, which can implement the decode module 104 and the cryptography module 124. In one embodiment, the decode module 104 and the cryptography module 124 can be implemented in software, as an executable program, and can be executed by a special or general purpose digital computer. The decode module 104 and the cryptography module 124 cooperate to decode (e.g., including error correction, etc.) the coded data and perform inverse transformations to reproduce the original information. For example, the cryptography module 124 may be implemented as a quadrature mirror filter that “knows” what algorithms or filters the encode module 102 and the cryptography module 122 used to code the data. Thus, once the cryptography module 124 receives the corresponding key or keys, the cryptography module 124 can perform the inverse transformation to recover the original information. As the second computer 112 includes similar components to those described in association with the first computer 110 of FIG. 2A, and similar operation with respect to cooperation of these components, the discussion of the same are omitted for brevity.

The software in memory 158 (FIGS. 2A and 2B) may include one or more separate programs, each of which comprises an ordered listing of executable instructions for implementing logical functions. In the example first computer 110 of FIG. 2A, the software in memory 158 includes the encode module 102 and the cryptography module 122 and a suitable operating system (O/S) 156. In the example second computer 112 of FIG. 2B, the software in memory 158 includes the decode module 104 and the cryptography module 124 and a suitable operating system (O/S) 156. The cryptography system 120 (FIG. 1) can be a source program, executable program (object code), script, and/or any other entity comprising a set of instructions to be performed. When a source program, then the program may be translated via a compiler, assembler, interpreter, or the like, which may or may not be included within memory 158, so as to operate properly in connection with the operating system 156. Furthermore, the cryptography system 120 can be written as (a) an object oriented programming language, which has classes of data and methods, or (b) a procedure programming language, which has routines, subroutines, and/or functions, such as C, C+, etc.

When the cryptography system 120 is implemented in software, as is shown in FIGS. 2A-2B, one or more modules of the cryptography system 120 can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The one or more modules of the cryptography system 120 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In some embodiments, functionality of one or more modules of the cryptography system 120 (FIG. 1) can be embodied in a custom made or a commercially available application specific integrated circuit (ASIC), for example, running embedded cryptography system software alone or in combination with the microprocessor 158. That is, the cryptography system functionality can be included in an ASIC that comprises, for example, a processing component such as an arithmetic logic unit for handling computations. Data transfers to and from memory 158 during coding can occur through direct memory access or via cooperation with the microprocessor 158, among other mechanisms.

In one embodiment, where the cryptography system 120 (FIG. 1) is implemented in hardware, one or more modules of the cryptography system 120 can be implemented with any or a combination of the following technologies: a discrete logic circuit(s) having logic gates for implementing logic functions upon data signals, an ASIC having appropriate combinational logic gates, a programmable gate array(s) (PGA), a field programmable gate array (FPGA), etc.

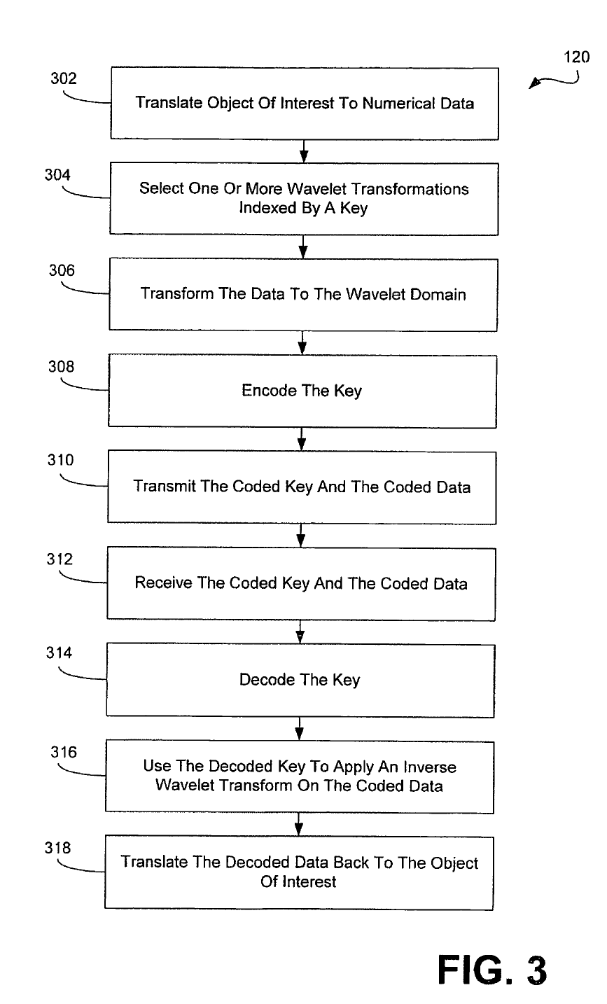

FIG. 3 is a flow diagram that illustrates an embodiment of a method employed by the cryptography system 120 (FIG. 1). Any process descriptions or blocks in the flow chart should be understood as representing modules, segments, or portions of code which include one or more executable instructions for implementing specific logical functions or steps in the process, and alternate implementations are included within the scope of the preferred embodiments in which functions may be executed out of order from that shown or discussed, including substantially concurrently or in reverse order, depending on the functionality involved, as would be understood by those reasonably skilled in the art of the present invention.

With continued reference to FIGS. 1-2B, block 302 includes translating objects of interest (e.g., text, image, sound, etc.) to a numerical code. The encoded module 102 can implement one of several well-known algorithms for achieving this translation functionality. Block 304 includes selecting one or more wavelet transformations indexed by a key. For example, the cryptography module 122 may select a wavelet transformation from a suite of available wavelet bases, for example, Pollen's library of wavelet bases. The wavelet bases can be indexed by a continuous parameter or a vector of continuous parameters, αᵢ, called the key. In other words, a different wavelet filter is selected based on the choice of angle αᵢ ranging between and including 0 and 2π. The angle acts as the index. For Pollen-type wavelets, which are an extensive library of well-known orthogonal wavelets, the key can take any real number value between (and including) 0 to 2π, each key value representing an angle in a circle. Further, more than one key may be selected, although this may result in increased complexity. In practice, selecting a different key corresponds to selecting a different filter. Although Pollen wavelets are used as an example implementation, it is possible to use other wavelet libraries. As will be demonstrated below, there may be significant differences in the performance of the filter with seemingly insignificant differences in the key (e.g., differences in the seventh decimal place between two keys can result in substantial filter performance differences). Thus, the transformed data is very sensitive to key differences.

Block 306 includes transforming the data to the wavelet domain. If more than one transformation is implemented by the cryptography module 122 (e.g., using more than one key), the last transformation should minimize the entropy (the entropy being defined on the normalized energy of the output of the previous wavelet transformation),
c=W_{α1}(W_{α2} . . . (W_{ακ}(Y)) . . . ), Eq. 1
where the W's represents wavelet transform functions, y represents the function to be transformed, and c represents the transformed function. Equation 1 illustrates that transformations can be used repeatedly on the same data with different keys (e.g., transforms of the transforms). One benefit this feature offers is the provision for an additional layer of security (e.g., multiple keys) and additional protection against noisy channel corruption. If corruption of data is suspected or estimated, wavelet shrinkage techniques may be implemented in the wavelet domain, as described further below. Further, some embodiments may use prior and expert information in protecting and recovering the signal, such as via Bayesian shrinkage of a possibly corrupted signal.

Block 308 includes encoding the key. Keys can be encoded by the encode module 102 and included with the encoded data for transmission or transferred separately.

Block 310 includes transmitting the coded key and the coded data. Again, the transmitting of the coded key and coded data may occur during the same time interval or at different time intervals, and via the same or different communication paths. The cryptography system 120 maintains a robustness to corruption errors having various statistical features, such as non-normal errors, dependent and self-similar errors, etc. Robustness is realized due to the inherent properties of wavelet transformations. For example, wavelet transformations exhibit a property referred to as disbalancing. Disbalancing refers to the distribution in energy, and in particular corresponds to a decrease in entropy (e.g., Shannon-type entropy). A signal is disbalanced if its energy is concentrated in a small number of coordinates, points, or coefficients. Disbalancing can be measured by Schur-convex measures such as Lorenz curves, Gini's index, Entropy, Fishlow Index, among others. Once the data is transformed by the cryptography module 122, the transformed data is transmitted in a signal in which a majority of information is represented with a few coefficients and the rest of the information in the signal can be disregarded. Well-known compression techniques may be employed to the transformed data to “shrink” the coefficients towards zero. Thus, various thresholding mechanisms (e.g., filters) may be employed when normal or structured noise is suspected. For non-normal (e.g., exponential noise, or other non-Gaussian noise distributions) noise, adaptive filtering according to well-known methods may be employed which evaluate the type of noise and provides an appropriate thresholding operation to filter-out the noise.

Beginning with the perspective from the decoding-side of the cryptography system 120, block 312 includes receiving the encoded key and the encoded and transformed data. Note that one with ordinary skill in the art would understand that some front-end processing of the received signal prior to input at the decode module 104 may occur. Block 314 includes decoding the key. Block 316 includes using the decoded key to apply an inverse wavelet transform on the coded data. The decode module 104 operates in cooperation with the cryptography module 124 to recover the original data, as represented by the following equations:
Y=W_{α1}′(W_{α2}′ . . . (W_{ακ}′(c)) . . . ) Eq. 2
or
y=W_{α1}′(W_{α2}′ . . . (W_{ακ}′([α₁, . . . , αₖ|c])) . . . ), Eq. 3
where y represents the function that results from multiple backward (i.e., inverse) transformations of c (c represents the transformed function that is to be inverse or backwards transformed), and W′ represents the inverse transform. Eq. 2 illustrates that there are no keys (α's) as part of the input. In other words, two options are provided, although not limited as such. In one option, the key is chosen by the decode module 104 in advance and the decode module 104 selects the proper W. In a second option, the keys are part of the code, and the keys are decoded first, transforms are selected, and the balance of the coded data is decoded. Eq. 3 shows that a key is first decoded and then returns a y (the pre-transformed function). Block 318 includes translating the decoded data back to the object of interest. This operation can be implemented by the decode module 104 using any one of a number of well-known translation techniques or algorithms.

Although Pollen filters have been described as one technique for implementing wavelet transforms, other wavelet transformations may be implemented. Preferably, a plurality of possible wavelet bases are included for selection. An optimal choice for a particular wavelet may be based on cost and/or performance concerns, among other reasons. For example, an orthonormal basis from a library of wavelet pack bases is usually selected by minimizing the data defined entropy cost function. In other words, given the data, a user attempting to choose a wavelet from an extensive library of wavelets may be confused as to which basis to use for the particular data at hand. One method may be to implement a variety of bases and evaluate the entropy of the results. An appropriate basis preferably minimizes the entropy (i.e., a disbalancing) of the transformed data.

It is possible to construct of a family of orthonormal wavelets that contains a continuum of many different wavelet bases. Several constructions are possible and one or more can be based on the available degrees of freedom in construction of wavelet bases. An example is the well-known Daubechies family in which the degree of freedom can be specified to minimize the phase, to minimize domain, to design vanishing moments, et. Vanishing moments are relevant in representing smooth signals, and are connected with locality of transformation and with decorrelation properties of wavelets (e.g., the input is autocorrelated, the output is not). Explaining further using a mathematical description of vanishing moments, consider that a k-th moment is the integral of \hat{ }kψ(x)dx, where ψ is a wavelet. If this integral is 0, first and second moments are 0.

As an example of one mechanism for implementing a wavelet transformation, a wavelet filter from the Pollen family is described using a filter with 4 to 6 taps. Let h be a wavelet filter of length 2N. There exists a continuous mapping from [0, 2π]^{N-1} to place a “wavelet solution” in the form of a sequence:
h={hₒ,h, . . . , h_{2N-1}}. Eq. 4

Pollen representations of all wavelet solutions of lengths 4(N=2) and 6(N=3) are given in Tables 1 and 2 below.

TABLE 1
Pollen parameterization for N = 2 (four-tap filters).

| n | hₙ for N = 2 |
|---|---|
| 0 | (1 + cosφ − sinφ)/s |
| 1 | (1 + cosφ + sinφ)/s |
| 2 | (1 − cosφ + sinφ)/s |
| 3 | (1 − cosφ − sinφ)/s |

TABLE 2
$Pollen parametrization for N = 3 ( six \text{-} tap filters ) [ s = \sqrt[2]{2} ]$

| | |
|---|---|
| n | hₙ for N = 3 |
| 0 | (1 + cosφ₁ − cosφ₂ − cosφ₁ cosφ₂ + sinφ₁− cosφ₂sinφ₁ − |
| | sinφ₂ + cosφ₁sinφ₂ − sinφ₁sinφ₂)/(2s) |
| 1 | (1 − cosφ₁ + cosφ₂ − cosφ₁ cosφ₂ + sinφ₁ + cosφ₂sinφ₁ − sinφ₂ − |
| | cosφ₁sinφ₂ − sinφ₁sinφ₂)/(2s) |
| 2 | (1 + cosφ₁cosφ₂ + cosφ₂sinφ₁ + cosφ₁sin₂φ + sinφ₁sinφ₂)/s |
| 3 | (1 − cosφ₁cosφ₂ − cosφ₂sinφ₁ − cosφ₁sin₂φ + sinφ₁sinφ₂)/s |
| 4 | (1 + cosφ₁ + cosφ₂ − cosφ₁cosφ₂ + sinφ₁ − cosφ₂sinφ₁ − |
| | sinφ₂ + cosφ₁sinφ₂ − sinφ₁sinφ₂)/(2s) |
| 5 | (1 + cosφ₁ − cosφ₂ − cosφ₁cosφ₂ − sinφ₁ + cosφ₂sinφ₁ + sinφ₂ − |
| | cosφ₁ − sinφ₂ − sinφ_{1 sinφ}₂)/(2s) |

Note that allowing a user to select φ₁ and φ₂ provides for a wavelet basis of his or her own choosing, and thus is referred to as parameterization. A special case of Pollens's representation for

$$ϕ = \frac{π}{6}$$

gives Daubechies minimum phase 2 vanishing moments or 4-taps filter, or what is referred to as a DAUB2 filter. The DAUB2 filter is a well-known 4-tap filter. Since Pollen bases are indexed by φε[0,2π]^{N-1}, the process of selecting an optimal basis, given the cost function, is a straightforward N−1 dimensional problem.

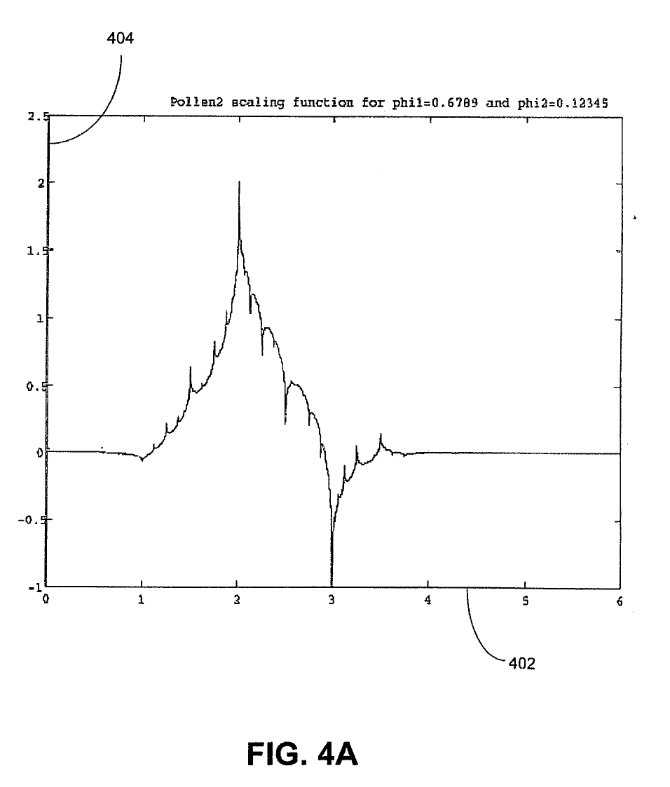

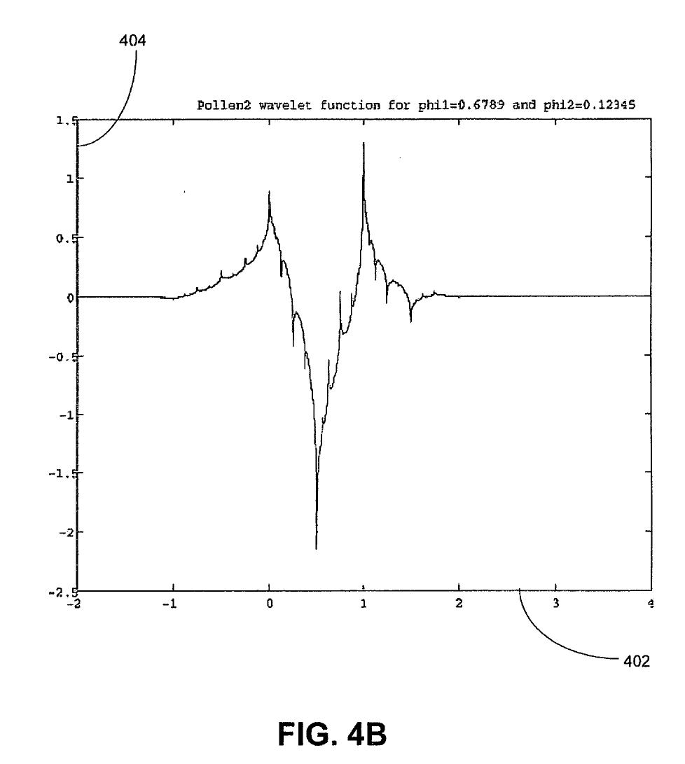

FIGS. 4A-4B depict wavelet and scaling functions for

$$ϕ = \frac{π}{4} ,$$

the wavelet function illustrated in FIG. 4A and the scaling function illustrated in FIG. 4B. In other words,

$$ϕ = \frac{π}{4}$$

corresponds to one parameter (e.g., a 4-tap filter). The φ_{1 and φ}₂ correspond to Table 2 (the 6-tap filter). The x-axis 402 and the y-axis 404 are respective x, y axes in a function, y=f(x). The function can be φ(x) (a scaling function) or ψ(x) (a wavelet function) connected with a particular filter. ψ(x) is a notation for the wavelet function often used to provide a theoretical basis to define the vanishing moments. An example of ψ(x) is provided in FIG. 4B. As an analogy, ψ(x) is to wavelet analysis somewhat as to what sin/cos is to trigonometric Fourier analysis.

The Pollen2 parameterizations (φ₁ and φ₂, Table 2) include the following keys: φ₁=0.67890, φ₂=0.12345. The low pass filter for this basis is given by {−0.0153, 02469, 0.8404, 0.4675, −0.1180, −0.0073}. Its low-pass coefficients are

$${h}_{o} = \frac{\sqrt{2}}{4} , {h}_{1} \frac{2 + \sqrt{2}}{4} , {h}_{2} = \frac{\sqrt{2}}{4} , {h}_{3} \frac{- 2 + \sqrt{2}}{4} ,$$

and the plots in FIGS. 4A-4B are obtained by point-to-point application of a Daubechie-Lagarias algorithm. Further information on Daubechie-Lagarias algorithms can be found in Daubechies, I. And Lagarias, J. (1991), “Two-scale difference equations, I. Existence and global regularity of solutions,” SIAM J. Math. Analysis, 22 (5), pp 1388-1410; Daubechies, I. and Lagarias, J. (1992), “Two-scale difference equations II. Local regularity, infinite products of matrices and fractals,” SIAM J. Math. Analysis, 23 (4), pp. 1031-1079; and Pinheiro, A. and Vidakovic, B. (1997), “Estimating the square root of a density via compactly supported wavelets, Computational Statistics & Data Analysis, 25, pp. 399-415, all herein incorporated by reference.

Matlab programming has been implemented to create various Pollen filters. The following m-function based on the equations in Table 1 above is provided using Matlab programming. The m-function gives low pass wavelet filter from the one parameter Pollen family (the parameter being “angle,” which indexes the family):
function h=MakePollen(φ)
% one parameter orthonormal Pollen family
% y=MakePollen(φ)
% input: φ—angle I(0, 2*π)
% output” h—low pass on wavelet filter
% φ=π/6 corresponds to Daubechies 4 tap on filter
% needs: Wavelab 802 module
s=2*sqrt (2):
h(1)=(1+cos(φ)−sin(φ))/s;
h(2)=(1+cos(φ)+sin(φ))/s;
h(3)=(1−cos(φ)+sin(φ))/s;
h(4)=(1−cos(φ)−sin(φ))/s;

Note that the “%” symbol represents comments, as would be understood by one familiar with Matlab programming.

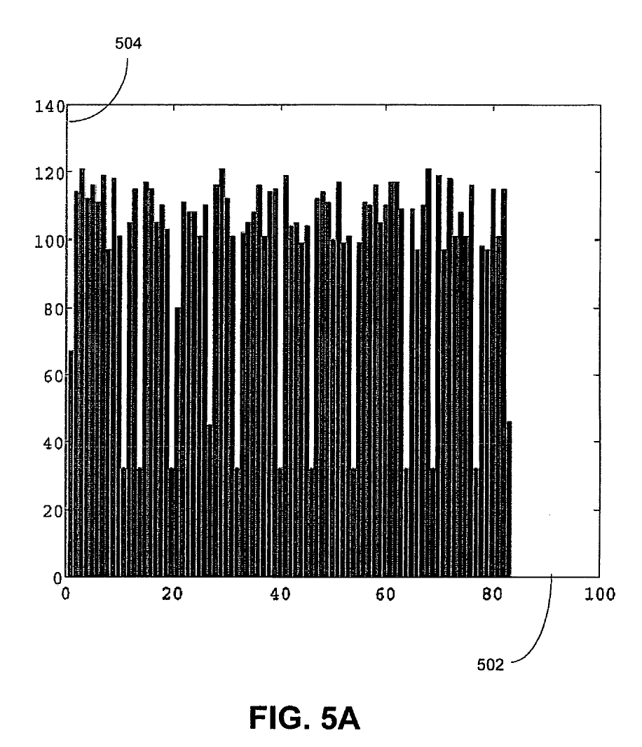

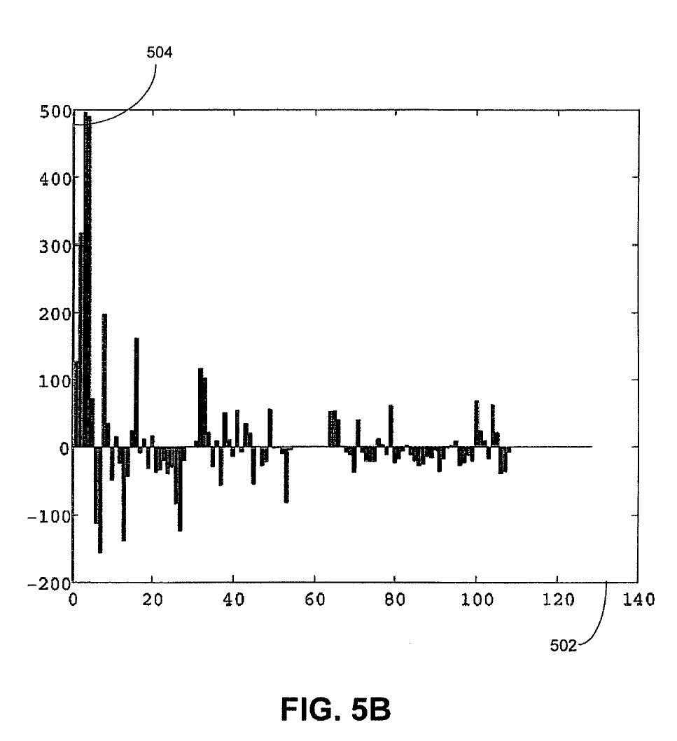

The following m-function based on the equations of Table 2 gives low pass wavelet filter from a two parameter Pollen family. This special case φ₁=−0.67890, and φ₂=0.12345 is shown in FIGS. 5A-5B. FIG. 5A shows the filter function for the normal domain and FIG. 5B shows the same for the wavelet domain transformed. The x-axis 502 represents the number of letters, including empty spaces. The y-axis 504 represents a numerical value for the letter. As shown, FIGS. 5B and 5A illustrate that the filter is more disbalanced in FIG. 5B than in FIG. 5A, which is desired. The filter for this selection of parameters is: {−0.0153, 0.2469, 0.8404, 40.4675, −0.1180, −0.0073}. The corresponding m-function in Matlab programming is illustrated below.
Function h=MakePollen2(φ₁, φ₂)
% two parameter orthonormal Pollen family
% y=MakePollen2(φ₁, φ₂)
% input: φ₁, φ₂—angle in[0, 2*π]
% output: h—low pass on wavelet filter of length 6
% needs: wavelet 802 module
s=2*sqrt (2);

$$\begin{matrix}h ( 1 ) = ( 1 + cos ( ϕ 1 ) - cos ( ϕ2 ) - cos ( ϕ1 ) * cos ( ϕ2 ) … + \\ sin ( ϕ1 ) - cos ( ϕ2 ) * sin ( ϕ1 ) - sin ( ϕ2 ) … + \\ cos ( ϕ1 ) * sin ( ϕ2 ) - sin ( ϕ1 ) * sin ( ϕ2 ) ) / ( 2 * s ) \\ h ( 2 ) = ( 1 - cos ( ϕ1 ) + cos ( ϕ2 ) - cos ( ϕ1 ) * cos ( ϕ2 ) … + \\ sin ( ϕ1 ) + cos ( ϕ2 ) * sin ( ϕ1 ) - sin ( ϕ2 ) … - \\ cos ( ϕ1 ) * sin ( ϕ2 ) - sin ( ϕ1 ) * sin ( ϕ2 ) ) / ( 2 * s ) \\ h ( 3 ) = ( 1 + cos ( ϕ1 ) * cos ( ϕ2 ) + cos ( ϕ2 ) * sin ( ϕ1 ) … - \\ cos ( ϕ1 ) * sin ( ϕ2 ) + sin ( ϕ1 ) * sin ( ϕ2 ) ) / s ; \\ h ( 4 ) = ( 1 + cos ( ϕ1 ) * cos ( ϕ2 ) - cos ( ϕ2 ) * sin ( ϕ1 ) … + \\ cos ( ϕ1 ) * sin ( ϕ2 ) + sin ( ϕ1 ) * sin ( ϕ2 ) ) / s ; \\ h ( 5 ) = ( 1 - cos ( ϕ1 ) + cos ( ϕ2 ) - cos ( ϕ1 ) * cos ( ϕ2 ) … - \\ sin ( ϕ1 ) - cos ( ϕ2 ) * sin ( ϕ1 ) + sin ( ϕ2 ) … + \\ cos ( ϕ1 ) * sin ( ϕ2 ) - sin ( ϕ1 ) * sin ( ϕ2 ) / ( 2 * s ) \\ h ( 6 ) = ( 1 + cos ( ϕ1 ) - cos ( ϕ2 ) - cos ( ϕ1 ) * cos ( ϕ2 ) … - \\ sin ( ϕ1 ) + cos ( ϕ2 ) * sin ( ϕ1 ) + sin ( ϕ2 ) … - \\ cos ( ϕ1 ) * sin ( ϕ2 ) - sin ( ϕ1 ) * sin ( ϕ2 ) ) / ( 2 * s ) ;\end{matrix}$$

The above Matlab programming or code illustrates an m-file that makes a Pollen2filter. As shown, the code represents a straightforward Matlab coding of the formulas from Table 2 above. Note that the use of Matlab is for illustrative purposes, and that other programming can be implemented to achieve the same or similar results. To illustrate the above described methodology, a simulation was performed using MATLAB©-based Donoho 's WaveLab 802, enhanced by the two m-functions described above (i.e., MakePollen1.m and MakePollen2.m). Note that Wavelab 802 is a public domain wavelet package for Matlab developed by Stanford University. The following sentence (represented in italics) was used as the original object (e.g., text object):
Cryptowave is using Pollen-type filters which produce continuum may wavelet bases.
   A level-2 coding scheme (e.g., two subsequent back-to-back transformations) was used in which 2 subsequent Pollen transformations returned back the exact sentence, as expected. In other words, the code was uncorrupted after the implementation of lossless forward and backward transformations, returning back the exact sentence as expected.

Another simulation was performed to show the sensitivity of the decoding scheme to minute changes in the key (e.g., changes in the wavelet filter that are smaller than 10⁻⁶ per filter tap). For example, two Pollen filters f₁ and f₂ were constructed such that ∥f₁−f₂∥²<2·10⁻¹², wherein filter f₁ was used to transform, and f₂ was used to inverse transform. The recovery was influenced substantially.

The following is the result of one Matlab session:
>>f₁=0.29142072440194
−0.29920333388859
0.24707418301363
0.84208402254301
0.16861187377098
0.16422609253213
All orthonormal wavelet filters {hₒ, . . . , hₙ} have the properties

$${\sum }_{i} {h}_{i} = \sqrt{2}$$

and

$${\sum }_{i} {h}_{i}^{2} = 1.$$

Deviations from the theory for Pollen filters, for any key, are machine −zeros (e.g., a very small number which the computer would recognize as zero, such as 10\hat{ }(−16)).
>>sum(f₁)−sqrt(2)
−2.220446049250313e−016
>>sum(f₁\hat{ }2)−1
−2.220446049250313e−016

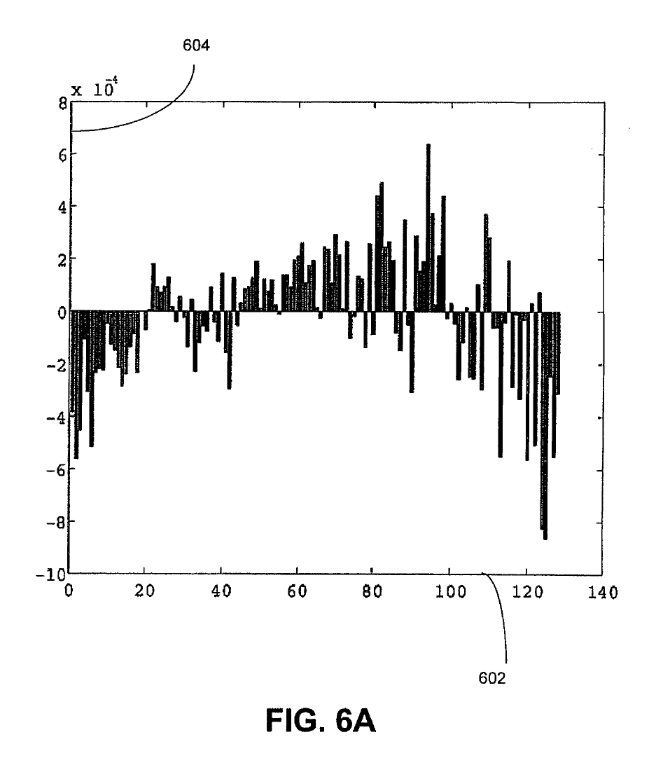

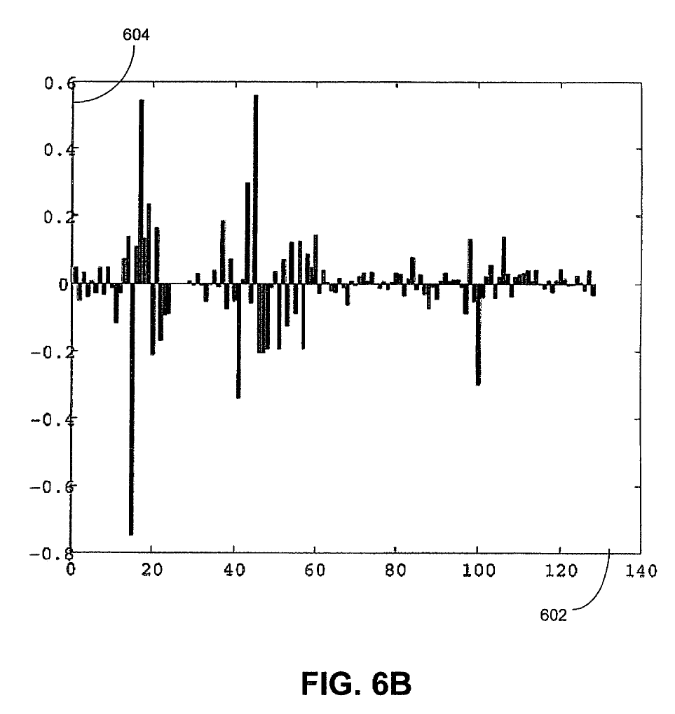

If the keys are only slightly changed, for example if (0.544444, 1.544444) goes to (0.54444, 1.54444), the filter-tap magnitudes change up to 10⁻⁶ but the corresponding decompositions (i.e., transformations) are influenced much more substantially.
>>f₂=MakePollen2 (0.54444, 1.54444)
f2=0.29141979754260
   −0.29920357950444
   0.24707418301363
   0.84208402254301
   0.16861280063033
   0.16422633814797
>>f₁−f₂
   1.0e−006*
   0.92685934394154
   0.24561584760496
   0.0000000000551
   0
   −0.92685934413583
   −0.24561584760496
>>sum((f₁−f₂)\hat{ }2)=1.838790776453065e−012
   The original text “recovered” with the wrong keys is as follows:
Bqxosnv ‘ud*hr*trhmg*Pollen-syod ehkseqr vgibh
produce bontinuum m’ny wavekdt aares
   Thus, a minute change in the key causes significant distortions of the recovered text, making it difficult to approximately recover the text. FIGS. 6A and 6B show the difference between the original and recovered numerical sequences. The x-axis 602 corresponds to a letter/symbol index, and the y-axis 604 corresponds to a numerical difference. In particular, FIG. 6A shows the errors that occur when the keys changed from (0.544444, 1.544444) to (0.54444, 1.54444). The barplot represents the difference between integer sequences (input and output) when filters are f₁ and f₂. FIG. 6B shows the errors that occur when the same filters are used, but coded sequence are hard-threshold at level λ=1.1, with improved results. Thus, once the data is transformed to the domain of wavelet coefficients, thresholding refers to the replacement of small-magnitude coefficients with a predetermined value, such as 0. One possible consequence of the thresholding is that the signal integrity is retained while removing noise. Mathematically, the coefficient can be replaced with 0 if its absolute value is less than the level, λ.

On the other hand, slight corruption of the coded sequence in the form of thresholding small elements of a sequence does not affect the recovery unless the thresholds are high. A hard thresholding rule was applied on the coded sequence with the threshold λ. When λ≦1 the recovery was exact. When λ was increased to 1.1, letters moved to their lexicographic neighbors (two letters change: “u” to “t” and “w” to “v”), as shown below:
Cryptowave is tsing Pollen-type filters which produce continuum many wavelet bases.

If normal noise is added to the transported signal, then its coding as an object in the wavelet domain provides protection against ultimate corruption. A simulation was performed to demonstrate the difference between wavelet and non-wavelet coding. Suppose the sentence Cryptowave is using Pollen-type filters which produce continuum many wavelet bases is coded numerically and corrupted by normal N(0, 0.2²) noise (i.e., each number represented is added a zero-mean σ²=0.2² variance normal variant). The cryptography system 120 (FIG. 1), with an optimal key and thresholding at level 1 (threshold λ=0.6) recovered the sentence with a single error: wavemet.

Cryptowave is using Pollen-type filters which produce continuum wavemet bases. Without use of the coding provided by the cryptography system 120, the recovered sentence reads, in this simulation, as follows:
Bqyotow ‘ud*is usimf*Poklen-txpd*ehkseqr wgibh orodubd bnmthnutm lamx*v ‘vdkdt b’rdr.

It should be emphasized that the above-described embodiments of the cryptography system 120 (FIG. 1), particularly, any “preferred” embodiments, are merely possible examples of implementations, merely set forth for a clear understanding of the principles of the cryptography system 120. Many variations and modifications may be made to the above-described embodiment(s) without departing substantially from the spirit and principles of the disclosure. All such modifications and variations are intended to be included herein within the scope of this disclosure.

1. A cryptography method, comprising:
transforming data into a wavelet domain;
encoding the transformed data; and
transmitting the encoded data.

2. The method of claim 1, further including selecting a wavelet filter among a plurality of wavelet filters to perform the transforming.

3. The method of claim 2, further including indexing the plurality of wavelet filters with a key.

4. The method of claim 3, wherein the key includes an angle comprising a real value ranging between zero and the multiplication of the number two and pi, inclusive.

5. The method of claim 3, further including encoding the key.

6. The method of claim 5, further including transmitting the encoded key.

7. The method of claim 6, wherein transmitting the encoded key includes at least one of transmitting the encoded key without the encoded data and transmitting the encoded key with the encoded data.

8. The method of claim 1, further including receiving the encoded data and the encoded key, decoding the key, inverse wavelet transforming the encoded data using the decoded key, and decoding the inverse wavelet transformed data.

9. The method of claim 1, further including selecting a wavelet filter among a plurality of wavelet filters to perform the transforming from a Pollen library of wavelet filters.

10. The method of claim 1, wherein transforming includes repeatedly transforming, each transformation implemented using a plurality of different keys.

11. The method of claim 1, further including translating an object to the data, the data formatted in numerical code.

12. The method of claim 11, wherein the object includes at least one of video, audio, and text.

13. A cryptography method, comprising:
receiving an encoded key and encoded data;
decoding the encoded key; and
inverse wavelet transforming the encoded data using the decoded key.

14. The method of claim 13, wherein receiving includes at least one of receiving the encoded key and the encoded data at the same time and receiving the encoded key and the encoded data at different times.

15. The method of claim 13, wherein decoding includes repeatedly decoding a plurality of encoded keys.

16. The method of claim 13, wherein inverse wavelet transforming includes repeatedly inverse wavelet transforming, each transformation implemented using a plurality of different keys.

17. The method of claim 13, further including decoding the inverse wavelet transformed data.

18. The method of claim 13, further including translating the decoded data to an object.

19. The method of claim 13, wherein the object includes at least one of video, audio, and text.

20. The method of claim 13, further including indexing a plurality of wavelet filters with a key, selecting a wavelet filter among the plurality of wavelet filters to perform transforming, transforming data into a wavelet domain using the selected wavelet filter, encoding the transformed data and the key, and transmitting the encoded data and the encoded key.

21. A cryptography system, comprising:
a first processor configured with first logic to transform data into a wavelet domain, encode the transformed data, and effect transmission of the encoded data.

22. The system of claim 21, wherein the first processor is further configured with the first logic to select a wavelet filter among a plurality of wavelet filters to perform the transforming.

23. The system of claim 22, wherein the first processor is further configured with the first logic to index the plurality of wavelet filters with a key.

24. The system of claim 23, wherein the key includes an angle comprising a real value ranging between zero and the multiplication of the number two and pi, inclusive.

25. The system of claim 23, wherein the first processor is further configured with the first logic to encode the key.

26. The system of claim 25, wherein the first processor is further configured with the first logic to effect the transmission of the encoded key.

27. The system of claim 26, wherein the first processor is further configured with the first logic to effect at least one of transmission of the encoded key without the encoded data and transmission of the encoded key with the encoded data.

28. The system of claim 26, further including a second processor configured with second logic to receive the encoded data and the encoded key, decode the key, inverse wavelet transform the encoded data using the decoded key, and decode the inverse wavelet transformed data.

29. The system of claim 21, wherein the second processor and the second logic are embodied in at least one of a consumer device, a computer, an applications specific integrated circuit, and a computer readable medium.

30. The system of claim 21, wherein the first processor is further configured with the first logic to select a wavelet filter among a plurality of wavelet filters to perform the transforming from a Pollen library of wavelet filters.

31. The system of claim 21, wherein the first processor is further configured with the first logic to repeatedly transform, each transformation implemented using a plurality of different keys.

32. The system of claim 21, wherein the first processor is further configured with the first logic to translate an object to the data, the data formatted in numerical code.

33. The system of claim 32, wherein the object includes at least one of video, audio, and text.

34. The system of claim 21, wherein the first processor and the first logic are embodied in at least one of a consumer device, a computer, an applications specific integrated circuit, and a computer readable medium.

35. A cryptography system, comprising:
a first processor configured with logic to receive an encoded key and encoded data, decode the encoded key, and inverse wavelet transform the encoded data using the decoded key.

36. The system of claim 35, wherein the first processor is further configured with the first logic to at least one of receive the encoded key and the encoded data at the same time and receive the encoded key and the encoded data at different times.

37. The system of claim 35, wherein the first processor is further configured with the first logic to repeatedly decode a plurality of encoded keys.

38. The system of claim 35, wherein the first processor is further configured with the first logic to repeatedly inverse wavelet transform, each transformation implemented using a plurality of different keys.

39. The system of claim 35, wherein the first processor is further configured with the first logic to decode the inverse wavelet transformed data.

40. The system of claim 35, wherein the first processor is further configured with the first logic to translate the decoded data to an object.

41. The system of claim 40, wherein the object includes at least one of video, audio, and text.

42. The system of claim 35, further including a second processor configured with second logic to index a plurality of wavelet filters with a key, select a wavelet filter among the plurality of wavelet filters to perform transforming, transform data into a wavelet domain using the selected wavelet filter, encode the transformed data and the key, and effect transmission of the encoded data and the encoded key.

43. The system of claim 42, wherein the second processor and the second logic are embodied in at least one of a consumer device, a computer, an applications specific integrated circuit, and a computer readable medium.

44. The system of claim 35, wherein the first processor and the first logic are embodied in at least one of a consumer device, a computer, an applications specific integrated circuit, and a computer readable medium.
